(19) United States
(12) Patent Application Publication
(10) Pub. No.: US 2025/0021952 A1
(43) Pub. Date: Jan. 16, 2025

(54) METHOD FOR REMOTELY TAKING CONTROL OF A PAYMENT TERMINAL OR SIMILAR, AND ASSOCIATED PAYMENT TERMINAL

(71) Applicant: BANKS AND ACQUIRERS INTERNATIONAL HOLDING, Suresnes (FR)

(72) Inventors: Laurent REIFFSTECK, Valence (FR); Olivier MOURAND, Andresy (FR)

(21) Appl. No.: 18/712,992

(22) PCT Filed: Nov. 23, 2022
(86) PCT No.: PCT/EP2022/082922

§ 371 Date: May 23, 2024

(30) Foreign Application Priority Data
Nov. 26, 2021 (FR) FR2112601

(51) Int. Cl. G06Q 20/10; G06Q 20/38; H04N 21/414

(52) U.S. Cl. CPC G06Q 20/108; G06Q 20/382; H04N 21/414

(57) ABSTRACT

A method for remotely taking control of a payment terminal. The method, implemented by a payment terminal software module, includes the steps of
implementation of security measures restricting take-over of control, including at least a step of deactivation, within the payment terminal, of the reading means of a payment device;
exchange of signalling data with a connection server, including the transmission of signalling data associated with the payment terminal and the receipt of signalling data associated with a potential remote terminal for the take-over of control;
establishment of a point-to-point connection between the remote terminal and the payment terminal, the connection including at least one continuous video broadcast stream of information displayed on a screen of the payment terminal and one stream for the receipt of at least one command from the remote terminal.

### TECHNICAL FIELD

The field of the invention is that of the electronic devices used for the implementation of software applications which involve or concern objects of confidential nature, and which must in this respect comply with certain security requirements defined in particular by standards or certifications. Amongst these devices, the invention relates more particularly to payment terminals or similar.

### PRIOR ART

Like many other communication terminals, payment terminals are more and more sophisticated, both in terms of hardware and software, in particular to meet the increasing requirements of the merchants using them. Numerous payment terminals therefore include for example, in addition to the traditional features for reading smart cards (contact or contactless) or magnetic stripe cards, means allowing them to be compatible with new payment solutions (e.g. mobile payment solutions such as Apple Pay® or Google Pay®, payment solutions via QR-code, restaurant ticket cards, etc.) or features for managing loyalty programs. More and more payment terminals also offer merchants the possibility of installing third party applications of their choice, for example downloadable on a distribution platform (e.g. applications such as calculators, customisation of till receipts, bill sharing, display of advertisements on the terminal screen, etc.). Such terminals generally comprise a large screen, to display the graphic interfaces associated with these applications. The drawback of these upgrades, which make payment terminals increasingly sophisticated, is that they generate new issues for the manufacturers selling them. In particular, operating a fleet of payment terminals is now subject to numerous operational constraints, including for example the need to train the users, provide them with technical support or troubleshooting assistance when they experience difficulties using their terminals, or the increasingly frequent implementation of maintenance and administration interventions. These operations (training, troubleshooting, maintenance, administration, etc.) are generally carried out by a technician in the field, on the merchant's site. However, these repeated trips generate significant costs for the operators of payment terminals.

To reduce these costs, assistance services by phone or in writing (for example by email or via an instant messaging system) have been set up by some operators, to reduce the number of trips of technicians in the field. The scope of action of these assistance services is nevertheless limited to the cases that are relatively easy to solve. In addition, even for these simple cases, the requests for assistance made in this way are not always optimum in terms of efficiency, since the merchants themselves must perform the operations on their payment terminal, according to the instructions provided by the assistance service, with all the difficulties inherent to this type of exchange (lack of clarity by one of the contacts, difficulty in understanding the operation to be carried out, no visual feedback, etc.).

There is therefore a need for a solution to simplify the management of a fleet of payment terminals, in particular to implement training, technical support, troubleshooting, maintenance and/or administration operations.

### SUMMARY OF THE INVENTION

This technique therefore proposes a solution aimed at overcoming some of the disadvantages of the prior art. This technique relates in fact to a method for remotely taking control of a payment terminal, implemented by a software module executed within said payment terminal, the method comprising the following steps:
implementation of security measures restricting said take-over of control, comprising at least a step of deactivation, within said payment terminal, of the reading means of a payment device;
exchange of signalling data with a connection server, said exchange comprising:
   the transmission of signalling data associated with said payment terminal to said connection server;
   the receipt, from said connection server, of signalling data associated with a potential remote terminal for said take-over of control;
establishment of a point-to-point connection between said remote terminal and said payment terminal, said connection comprising at least:
   one continuous video broadcast stream of information displayed on a screen of said payment terminal, called media stream;
   one stream for the receipt of at least one command from said remote terminal, called control stream.

In this way, the method according to the proposed technique simplifies the support, training, administration or maintenance operations of a payment terminal, by allowing a remote operator to temporarily and remotely take control of such a payment terminal, within a clearly defined security framework to ensure in particular that the terminal remains compliant with various security and/or regulatory standards.

In a particular embodiment, the implementation of security measures comprises at least one step of checking the presence, within said payment terminal, of at least one structure of data representative of restrictions to be applied to said take-over of control.

In a particular embodiment, said method is interrupted in the absence, within said payment terminal, of said at least one structure of data representative of restrictions to be applied to said take-over of control.

In a particular embodiment, the method comprises, after said step of establishing a point-to-point connection, at least one iteration of the following steps:
receipt of a command from said remote terminal, via said control stream;
check of compliance of said command with a security policy;
in case of positive compliance, execution of said command on said payment terminal.

In a particular embodiment, said check of compliance comprises checking that an application associated with said command is:
present in a white list of applications whose execution on the payment terminal is authorised during said remote take-over of control; or
absent from a black list of applications whose execution on the payment terminal is prohibited during said remote take-over of control.

In a particular embodiment, the method comprises a step of logging said at least one command received from the remote terminal in a trace file stored in said payment terminal.

In a particular embodiment, said trace file is downloaded to a maintenance server, upon receipt of an item of data representative of an end of said remote take-over of control.

According to another aspect, this technique also relates to a payment terminal configured to allow a remote take-over of control of said payment terminal. Such a payment terminal comprises:
means for the implementation of security measures restricting said take-over of control;
means for the exchange of signalling data with a connection server, said exchange means comprising:
   means for the receipt, from said connection server, of signalling data associated with a potential remote terminal for said take-over of control;
   means for the transmission, to said connection server, of signalling data associated with said payment terminal;
means for the establishment of a point-to-point connection between said remote terminal and said payment terminal, said connection comprising at least:
   one continuous video broadcast stream of information displayed on a screen of said payment terminal, called media stream;
   one stream for the receipt of at least one command from said remote terminal, called control stream.

The means of said terminal can be adapted to the implementation of any one of the embodiments of the method of this application.

According to another aspect, the proposed technique also relates to a computer program product downloadable from a communication network and/or stored on a computer-readable medium and/or executable by a microprocessor, comprising program code instructions to execute a method for remotely taking control of a payment terminal as described previously, when it is executed on a computer.

The proposed technique also relates to a computer-readable storage medium storing a computer program comprising program code instructions to execute the steps of the method as described previously, in any one of its embodiments.

Such a storage medium can be any entity or device capable of storing the program. For example, the medium can comprise a storage means, such as a ROM, for example a CD ROM or a microelectronic circuit ROM, or a magnetic recording means, for example a USB flash drive or a hard disk.

In addition, such a recording medium can be a transmissible medium such as an electrical or optical signal, that can be routed via an electrical or optical cable, by radio or by other means, such that the computer program it contains can be executed remotely. The program according to the invention can be downloaded in particular on a network, for example the Internet.

The various above-mentioned embodiments can be combined together to implement the invention.

### FIGURES

Other characteristics and advantages of the invention will appear more clearly on reading the description which follows of a preferred embodiment, given as a simple illustrative and non-limiting example, and referring to the attached drawings, in which:

FIG. 1 shows the main steps of a method for remotely taking control of a payment terminal in a particular embodiment of the proposed technique;

FIG. 2 provides an example of network environment in which the method according to the proposed technique is likely to be implemented, in a particular embodiment;

FIG. 3 describes a simplified architecture of a payment terminal for the implementation of the proposed technique, in a particular embodiment.

### DETAILED DESCRIPTION OF THE INVENTION

This techniques relates to a method for remotely taking control of a payment terminal. “Payment terminal” means in this case a traditional electronic payment terminal, in other words a dedicated device specifically designed to implement payment operations, but also any device provided with hardware and software means allowing it to be used instead of a traditional electronic payment terminal to implement payment operations, while complying with the same security requirements (such devices “similar” to a payment terminal include for example portable devices such as smartphones or tablets, comprising at least one secure element and cryptographic means adapted to implement applications processing sensitive or confidential data). This technique aims more precisely to allow a remote identified user, typically a technician or an expert belonging to a technical support department, to temporarily and remotely take control of such a payment terminal, in order for example to perform support operations (e.g. to help a merchant who is experiencing difficulties when using their terminal) as well as training, administration or maintenance operations. It is thus possible to reduce the number of interventions in the field and therefore limit the costs associated with such trips, while guaranteeing that these operations are processed as efficiently as possible since they are carried out by operators trained specifically for these tasks (and not by the merchants themselves). As demonstrated below, various types of protection are nevertheless provided within the framework of this technique, to ensure that the proposed method for remotely taking control (and the payment terminal configured to implement this method) comply with the rules and constraints applicable in the field of payment. The use of payment terminals is in fact subject to strict, mandatory and imposed security regulations. More particularly, these terminals must be certified compliant with various security standards, including for example the Payment Card Industry (PCI) standards, such as for example the Payment Card Industry-PIN Transaction Security (PCI-PTS) standard, these standards defining security requirements concerning the physical design of the hardware as well as the software part implemented in these terminals. The method according to the proposed technique provides mechanisms for restricting remote take-over of control of a payment terminal, so that these standards continue to be respected.

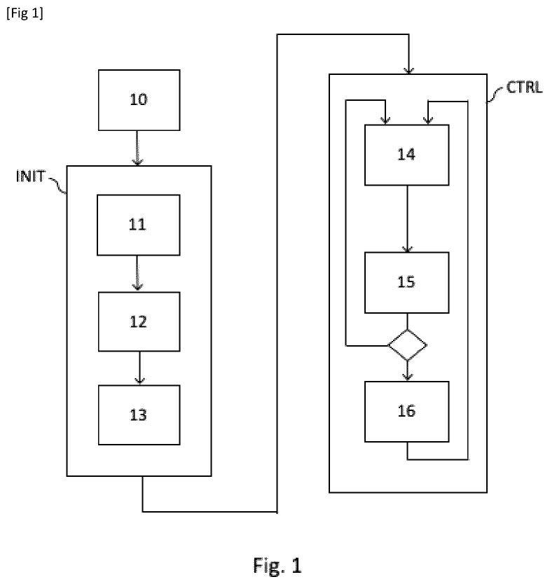

This method for remotely taking control, shown referring to FIG. 1 in a particular embodiment, is implemented by a dedicated software module (for example a dedicated application) executed in the payment terminal, for example by a secure processor.

According to the proposed technique, the remote take-over of control of a payment terminal is subject to the prior implementation, in a step 10, of security measures aimed at limiting the scope of the remote take-over of control of the payment terminal, and thereby ensuring that the terminal remains compliant with the applicable security standards (e.g. as an illustrative and non-limiting example, compliance with the PCI standards).

These security measures comprise in particular, in a particular embodiment of the proposed technique, the deactivation (or blocking) at least one feature of the payment terminal. Such deactivations can be implemented using dedicated application programming interfaces (APIs), provided for example by the payment terminal operating system. According to a particular characteristic, all the means for obtaining information from any payment device (e.g. payment card, smartphone or connected watch equipped with payment features, etc.) are thus deactivated within the payment terminal. This includes for example deactivating the various reading means available in the payment terminal: smart card reader, magnetic stripe card reader, contactless NFC readers, QR-code reader, etc. Thus, the payment terminal cannot be used to implement a payment transaction when it is remotely controlled.

These security measures also comprise, in a particular embodiment of the proposed technique, checking the presence, within the payment terminal, of at least one structure of data representative of restrictions to be applied when taking control of the payment terminal, once control has become effective. According to a particular characteristic, this data structure consists for example of a signed file, listing for example, amongst the applications installed on the payment terminal (or likely to be installed), those which are authorised to be executed during a remote take-over of control (case of a white list of applications) or, on the contrary, those which are not authorised to be executed during a remote take-over of control (case of a black list of applications). According to a particular characteristic, if absence of such a data structure in the payment terminal is detected, for example when starting the dedicated application for remotely taking control, the method is interrupted immediately. In this case, steps 11, 12 and 13 of initialising a session for remotely taking control, described below, are not implemented, thereby prohibiting any remote take-over of control of the payment terminal.

In a particular embodiment, once the security measures of step 10 have been implemented, and when application of these measures has not identified the need to interrupt the method for remotely taking control, a phase INIT of initialising a session for remotely taking control is implemented, comprising steps 11, 12, and 13 described below.

More particularly, this initialisation phase comprises an exchange of signalling data between the payment terminal and a connection server, shown referring to steps 11 and 12 of FIG. 1. This exchange is for example carried out when processing a request to take control of the payment terminal, which may originate, according to various particular embodiments, either from the payment terminal itself (in this case, the payment terminal issues a request for its control to be remotely taken over: it therefore informs the connection server that it is available for its control to be taken over), or from a potential remote terminal for said take-over of control (in this case, the remote terminal issues a request to remotely take control of the payment terminal: it thus informs the connection server that it is available to take control of the payment terminal).

During this exchange, in a step 11, the payment terminal transmits signalling data associated with the payment terminal to the connection server, so that the connection server transfers them to a potential remote terminal for take-over of control.

In a step 12, the payment terminal receives, from the connection server and via the dedicated software module, signalling data associated with the potential remote terminal for take-over of control. Such a remote terminal is typically the workstation (e.g. a computer, tablet or smartphone) of a support department operator available to handle operations to be carried remotely on the payment terminal (technical support, training, maintenance, administration, etc.).

Depending on whether the request to take control of the payment terminal was initiated by the payment terminal itself or by a potential remote terminal for take-over of control, steps 11 and 12 can be executed in the order shown on FIG. 1 (step 11 then step 12), or in the reverse order (step 12 then step 11).

In a step 13, a point-to-point connection (also called a peer-to-peer connection) is established between the payment terminal and the remote terminal (for example between the dedicated application for taking control on the payment terminal side, and a web browser on the remote terminal side), using signalling data associated respectively with the payment terminal and the remote terminal, previously exchanged via the connection server during steps 11 and 12. In the framework of this document, a “point-to-point” connection means a connection allowing communication between the payment terminal and the remote terminal without necessarily transiting via the connection server, such communication nevertheless being likely to transit via other network devices acting as relay servers between the payment terminal and the remote terminal, as described below.

According to the proposed technique, this point-to-point connection comprises at least one media stream and one control stream.

The media stream is a continuous video broadcast stream (streaming) transmitted to the remote terminal, representative of the information displayed on the screen of the payment terminal. Thus, a real-time video stream (or quasi real-time, to within a low latency time) of what is happening on the screen of the payment terminal can be displayed on at least a part of a screen of the remote terminal.

The control stream is a channel used for the receipt of commands from the remote terminal. It consists for example of a bidirectional channel of data exchanges between the payment terminal and the remote terminal.

Steps 10, 11, 12 and 13, described previously, are for example implemented when starting, on the payment terminal, the dedicated software module for remotely taking control (the means of contacting the connection server, e.g. its IP address, being for example predefined in the configuration parameters of this software module).

Whatever the case, the establishment of a point-to-point connection between the remote terminal and the payment terminal described in relation to step 13 is subject to the prior implementation of the security measures described in relation to step 10: establishment of the point-to-point connection is only implemented if application of these measures has not identified the need to interrupt the method for remotely taking control. Thus, step 10 is necessarily implemented before step 13. In a particular embodiment not shown, step 10 can however be carried out after steps 11 and 12 for the exchange of signalling data with the connection server.

Once the point-to-point connection has been established, the phase INIT of initialising the session for remotely taking control is finished, and a phase of effective control CTRL starts, during which the payment terminal can be controlled remotely from the remote terminal as long as this session for taking control remains open.

In a step 14 of the control CTRL phase, the software module for remotely taking control of the payment terminal receives a command from the remote terminal, via the control stream of the point-to-point connection established during phase INIT of initialising the session. This command belongs for example to the group of commands comprising commands (list provided as an illustrative, non-limiting example) for:
starting an application installed on the payment terminal;
opening the payment terminal parameters menu, to access the device configuration and possibly modify this configuration;
starting a self-diagnosis of the payment terminal, if such a feature is available on the payment terminal;
navigating between various applications open on the payment terminal;
using an application being executed on the payment terminal;
taking a screen shot of the display of the payment terminal.

In a step 15, the command received is checked to make sure that it complies with a security policy aimed at ensuring that the security requirements defined, for example by the PCI standards, continue to be respected. In other words, during this step 15, the command received is checked to ensure that it is an authorised command in the framework of a remote control of the payment terminal. This check may in particular be based, in a particular embodiment of the proposed technique, on the structure of data representative of restrictions to be applied, whose presence is checked when starting the software module for taking control of the payment terminal (during step 10). When the command received is associated with an application (for example because it is a command to start this application, or to use a feature provided by this application), a check is carried out for example, in a particular embodiment, to make sure that the remote control of this application is in fact authorised, by ensuring that the application concerned is present in a white list of applications whose execution on the payment terminal is authorised during a remote take-over of control, or on the contrary that it is absent from a black list of applications whose execution on the payment terminal is prohibited during said remote take-over of control.

When the command received does not comply with the applicable security policy (for example because the application that the operator is trying to start remotely is an unauthorised application, which may be the case for a payment application in particular), it is not executed, and the software module for taking control waits for the receipt of a new command. On the contrary however, (positive compliance) the command is executed on the payment terminal, in a step 16. The video stream broadcast continuously to the remote terminal (i.e. the media stream) is then used, on the remote terminal, to view in real time the results of executing the command by the payment terminal (at least when execution of this command changes the information displayed on the screen of the payment terminal). Once the command has been executed, the software module for taking control waits for the receipt of a new command. Multiple iterations of steps 14, 15 and 16 described previously can be implemented during the session for remotely taking control CTRL of the payment terminal. A remote operator can therefore carry out, on the payment terminal, via the remote terminal, numerous operations in the same way as if they were physically present in front of the payment terminal (provided that these operations are included in the actions authorised during a remote take-over of control).

In one embodiment, the method for taking control also comprises logging, in a data structure (typically a database, or a trace file, also called log file), operations carried out remotely during the session for controlling CTRL the payment terminal. This logging step comprises for example the recording, in a trace file, of the commands received from the remote terminal during step 14. According to a particular characteristic, the result of checking the compliance of a command, obtained in step 15, is also logged, i.e. recorded in the trace file. Similarly, information concerning the execution of a command, during step 16, can also be recorded in this trace file. The trace file (i.e. the logging data structure) is thus supplied as the commands are received, throughout the remote control session CTRL.

When the remote control session is ended-either by the remote operator, from the remote terminal, or by the user, from the payment terminal, for example using a button provided for this purpose by the dedicated application for remotely taking control-various operations are implemented, in addition to interrupting the point-to-point connection between the remote terminal and the payment terminal. In particular, the features of the payment terminal which had been deactivated in step 10 are restored. For example, the various readers of the payment terminal (smart card reader, magnetic stripe card reader, contactless reader, etc.) are unblocked and are functional again. In a particular embodiment, the trace file or data associated with the current control session or the session which has just ended is downloaded on a maintenance server or a server for the management of a fleet of payment terminals (such a server may possibly be the same as the connection server), so that the content of this file or data can be accessed for subsequent consultation, for example by a support department. This trace file or data can possibly be stored in an encrypted form on the server, to prevent its content from being processed by unauthorised persons.

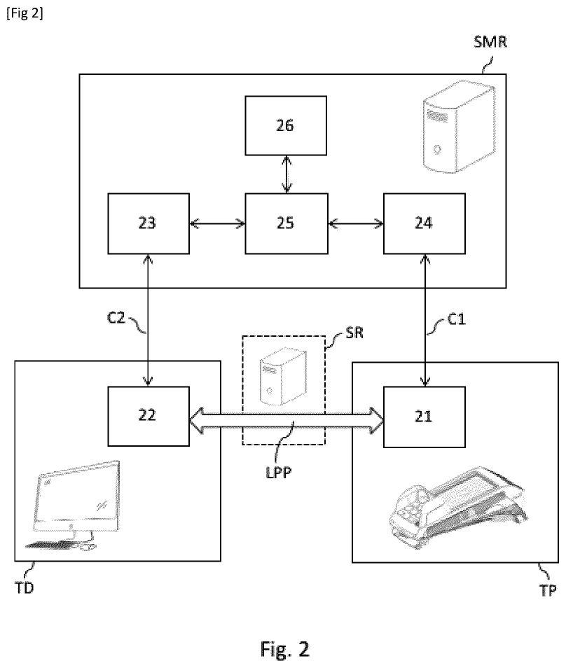

We will now describe, referring to FIG. 2, an example of network environment in which the method according to the proposed technique is implemented, in a particular embodiment. As described previously, such an environment comprises various entities connected to a communication network (typically the Internet), these entities including at least a payment terminal TP, a remote terminal TD, and a connection server SMR. The payment terminal TP and the remote terminal TD are adapted to exchange data with the connection server SMR, respectively via a communication channel C1 and a communication channel C2, according to various suitable communication protocols.

The payment terminal TP comprises a software module 21 for remotely taking control, which typically consists of a dedicated application installed on the payment terminal. When it is started, this application implements the various steps of the method for remotely taking control, according to one of the embodiments already described referring to FIG. 1.

More particularly, in one embodiment of the proposed technique, the establishment of a point-to-point connection LPP between the payment terminal TP and a potential remote terminal TD for its take-over of control is based on the Web Real-Time Communication (WebRTC) technology. In the context of a WebRTC communication, the connection server SMR is used to connect the payment terminal TP and the remote terminal TD, via the exchange of signalling data during a session initialisation phase. After this initialisation phase, a point-to-point (i.e. peer-to-peer) connection LPP is established, comprising a media stream and a control stream as defined previously. These two streams do not normally transit via the connection server SMR, but directly (possibly via one or more TURN or STUN type relay servers, if required due to network constraints, as described below in the document) between the dedicated application 21 started on the payment terminal TP and a client module 22, typically a web browser, started on the remote terminal TD. In order to communicate with the client module 22 of the remote terminal TD, firstly, and with the software module 21 of the payment terminal TP, secondly, the connection server SMR comprises respectively a server module 23 and an assignment module 24, these two modules 23 and 24 being interconnected via an interconnection module 25. Thus, a signalling channel is established between the payment terminal TP and the remote terminal TD, via these modules 23, 24 and 25 of the connection server SMR. This signalling channel is used to negotiate, during the session initialisation phase, the characteristics of the point-to-point connection (network connection, address resolution, ports, video formats, codecs, etc.), via the exchange of Session Description Protocol (SDP) offers and responses on the communication channels C1 and C2. During this initialisation phase, self-signed certificate seals are also exchanged between the dedicated application 21 started on the payment terminal TP and the web browser 22, started on the remote terminal TD, to establish trust between these two modules during the point-to-point session. The WebRTC technology also offers various mechanisms to determine possible configurations or network restrictions (e.g. architectures implementing Network Address Translation (NAT) devices, presence of firewalls, etc.) likely to complicate or prevent a direct correction between the payment terminal TP and the remote terminal TD, and implement bypass solutions if necessary. These mechanisms are not described in more detail in this document, but they include in particular the use of an Interactive Connectivity Establishment (ICE) protocol, and Session Traversal Utilities for NAT (STUN) and Traversal Using Relays around NAT (TURN) servers. They are used for example to identify the need to use a possible relay server SR to allow communication between the payment terminal TP and the remote terminal TD.

Various protocol stacks are then used to manage the point-to-point connection LPP established during the WebRTC communication. More particularly, the control stream is transported using the Stream Control Transmission Protocol (SCTP) and is based on the Datagram Transport Layer Security (DTLS) protocol to guarantee the confidentiality and authenticity of the SCTP packets exchanged. Encryption is carried out in particular by means of the self-generated certificates, whose seals have previously been exchanged during the session initialisation phase. The media stream, providing the continuous video broadcast of information displayed on the screen of the payment terminal TP is transported using the Secure Real-Time Transport Protocol (SRTP) and is also based on the DTLS protocol to guarantee the confidentiality and authenticity of the SRTP packets exchanged. Thus, the LPP connection is secure.

In addition to its role of intermediate server used to connect a payment terminal to a remote terminal, the connection server SMR may include other features. For example, the SMR server can also be used for the management (storage, consultation, deletion, etc.) of trace files consolidated after the sessions for remotely taking control of payment terminals, in which case it also comprises a logging module 26 responsible for implementing these features.

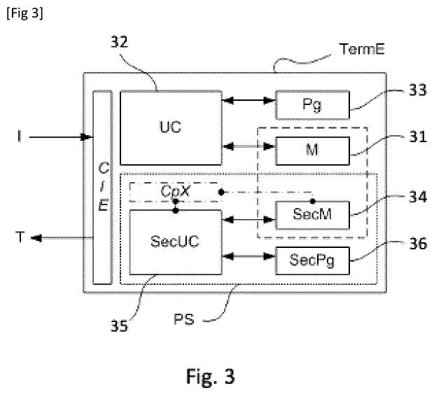

According to another aspect, the proposed technique also relates to a payment terminal, for which a simplified architecture is described referring to FIG. 3, in a particular embodiment. Such an electronic payment terminal (TermE) comprises a memory 31, a processing unit 32 equipped for example with a microprocessor, and controlled by a computer program 33. The electronic terminal also comprises a secure memory 34, which can be merged with the memory 31 (as shown in dotted lines, in this case the memory 31 is a secure memory), a secure processing unit 35 equipped for example with a secure microprocessor and with physical protection measures (physical protection around the chip, by lattice, vias, etc. and protection on the data transmission interfaces), and controlled by a computer program 36 specifically dedicated to this secure processing unit 35, this computer program 36 implementing all or part of the method for remotely taking control as described previously. The group composed of the secure processing unit 35, the secure memory 34 and the dedicated computer program 36 forms the secure portion (PS) of the electronic terminal. In at least one embodiment, this technique is implemented as a set of programs installed partly or totally on this secure portion of the transaction processing terminal. In at least one other embodiment, this technique is implemented as a dedicated component (CpX) capable of processing data of the processing units and installed partly or totally on the secure portion of the transaction processing terminal. In addition, the terminal also comprises communication means (CIE) consisting for example of network components (WiFi, 3G/4G/5G) allowing the terminal to receive data (I) from entities connected to one or more communication networks (for example a connection server, STUN and/or TURN servers, a remote terminal, etc.) and to transmit processed data (T) to such entities.

Such a payment terminal further comprises, depending on the embodiments:
means for the implementation of security measures restricting said take-over of control;
means for the exchange of signalling data with a connection server, the exchange means comprising means for the receipt, from this connection server, of signalling data associated with a potential remote terminal for said take-over of control and means for the transmission, to the connection server, of signalling data associated with the payment terminal;
means for the establishment of a point-to-point connection between the remote terminal and the payment terminal, said connection comprising at least:
one continuous video broadcast stream, to the remote terminal, of information displayed on a screen of the payment terminal, called media stream;
one stream for the receipt of at least one command from said remote terminal, called control stream.

This technique, in any one of the embodiments described previously, thus provides a solution simplifying the management of a fleet of payment terminals, by allowing the remote implementation of numerous operations (training, technical support, troubleshooting, maintenance, administration, etc.), in a secure framework and in compliance with the security standards applicable in the field of payment.

1. A method for remotely taking control of a payment terminal, implemented by a software module executed within said payment terminal, said method comprising the following steps:
implementation of security measures restricting a take-over of control, comprising at least a step of deactivation, within said payment terminal, of the reading means of a payment device;
exchange of signalling data with a connection server, said exchange comprising:
a transmission of signalling data associated with said payment terminal to said connection server;
a receipt, from said connection server, of signalling data associated with a potential remote terminal for said take-over of control;
establishment of a point-to-point connection between said remote terminal and said payment terminal, said connection comprising at least:
one continuous video broadcast stream of information displayed on a screen of said payment terminal, called media stream;
one stream for the receipt of at least one command from said remote terminal, called control stream.

2. The method according to claim 1, wherein the implementation of security measures comprises at least one step of checking a presence, within said payment terminal, of at least one structure of data representative of restrictions to be applied to said take-over of control.

3. The method according to claim 2, wherein said method is interrupted in an absence, within said payment terminal, of said at least one structure of data representative of restrictions to be applied to said take-over of control.

4. The method according to claim 1, wherein it comprises, after said step of the establishment of the point-to-point connection, at least one iteration of the following steps:
receipt of a command from said remote terminal, via said control stream;
check of compliance of said command with a security policy;
in case of positive compliance, execution of said command on said payment terminal.

5. The method according to claim 4, wherein said check of compliance comprises checking that an application associated with said command is:
present in a white list of applications whose execution on the payment terminal is authorised during said remote take-over of control; or
absent from a black list of applications whose execution on the payment terminal is prohibited during said remote take-over of control.

6. The method according to claim 4, further comprising a step of logging said at least one command received from the remote terminal in a trace file stored in said payment terminal.

7. The method according to claim 6, wherein said trace file is downloaded to a maintenance server, upon receipt of an item of data representative of an end of said remote take-over of control.

8. A payment terminal configured to allow a remote take-over of control of said payment terminal, comprising:
means for an implementation of security measures restricting said take-over of control, comprising means for deactivation, within said payment terminal, of reading means of a payment device;
means for an exchange of signalling data with a connection server, said exchange means comprising:
means for a transmission, to said connection server, of signalling data associated with said payment terminal;
means for a receipt, from said connection server, of signalling data associated with a potential remote terminal for said take-over of control;
means for an establishment of a point-to-point connection between said remote terminal and said payment terminal, said connection comprising at least:
one continuous video broadcast stream of information displayed on a screen of said payment terminal, called media stream;
one stream for the receipt of at least one command from said remote terminal, called control stream.

9. A computer program product downloadable from a communication network and/or stored on a non-transitory computer-readable medium and/or executable by a microprocessor, comprising program code instructions to execute the method according to claim 1, when it is executed by a computer.
